(19) United States
(12) Patent Application Publication
(10) Pub. No.: US 2026/0286944 A1
(43) Pub. Date: Sep. 24, 2026

(54) HYBRID DRIVE SYSTEM ASSOCIATED WITH WELL CEMENTING SYSTEM

(71) Applicant: Caterpillar Inc., Peoria, IL (US)

(72) Inventor: John Tanner, Dunlap, IL (US)

(73) Assignee: Caterpillar Inc., Peoria, IL (US)

(21) Appl. No.: 19/082,363

(22) Filed: Mar. 18, 2025

(51) Int. Cl. F04B 17/03; E21B 33/13; G05B 19/4155

(52) U.S. Cl. CPC F04B 17/03; E21B 33/13; G05B 19/4155; G05B 2219/41307

(57) ABSTRACT

A hybrid drive system associated with a well cementing system includes an electric drive system generating a first energy supply. The electric drive system includes one or more electric motors. The hybrid drive system also includes a torque generating system generating a second energy supply. The torque generating system includes one or more torque generating devices. The electric drive system and the torque generating system are disposed in a parallel arrangement. The hybrid drive system further includes a controller communicably coupled with each of the electric drive system and the torque generating system. The controller is configured to determine at least an energy demand and control the electric drive system and the torque generating system to output at least one of the first energy supply via the electric drive system and the second energy supply via the torque generating system, based on the energy demand of the well cementing system.

### TECHNICAL FIELD

The present disclosure relates to a well cementing system, a hybrid drive system associated with the well cementing system, and a method of controlling a well cementing operation.

### BACKGROUND

Typically, in oil and gas industries, a well cementing operation is performed for construction, completion, and abandonment of oil and gas well bores. The well cementing operation involves a pressure testing to verify that an integrity of the piping to ensure there are no leaks. The well cementing operation also involves a pumping operation to pump a cement slurry into a well bore and into the space between the casing and the drilled rock. The pressure testing and the pumping operation are used to ensure that the cement has effectively sealed and can withstand pressures which are encountered by the well bore. A pump is used to perform the pressure testing and the pumping operation. For performing the pressure testing and the pumping operation, the pump required high torque and high power.

In some examples, an electrical powertrain including an oversized electric motor may be used to provide a required high torque and high power to the pump for the pressure testing and the pumping operation. The electrical powertrain also requires a high voltage DC power supply and a large inverter. Such oversized components may require large space for mounting and may increase packaging costs as well as overall installation costs, which is not desirable.

U.S. Pat. No. 10,267,149 describes a system that combines or integrates electric and hydraulic power producing technologies into a single compact motor by means of common or shared rotor and stator elements. The invention allows optimized power, torque, performance, and energy usage in electric and electric-hybrid vehicles and offers reduced weight and lower production costs due to the use of common or shared components. The combined motor's electric and hydraulic power producing elements are preferably coaxial and coplanar, permitting axial compactness and enabling efficient space utilization in the vehicle. In typical electric vehicle drive cycles disproportionately large energy losses occur during the launch acceleration and brake energy recovery modes of vehicle torque demand. The combined motor increases overall efficiency by substituting high-efficiency hydraulic torque for low-efficiency electric torque during these modes. These peak efficiency substitutions conserve battery energy during launch acceleration, maximizing the state of charge to extend driving range or runtime.

### SUMMARY OF THE DISCLOSURE

In an aspect of the present disclosure, a hybrid drive system associated with a well cementing system is provided. The hybrid drive system includes an electric drive system that generates a first energy supply. The electric drive system includes one or more electric motors. The hybrid drive system also includes a torque generating system that generates a second energy supply. The torque generating system includes one or more torque generating devices. The electric drive system and the torque generating system are disposed in a parallel arrangement. The hybrid drive system further includes a controller communicably coupled with each of the electric drive system and the torque generating system. The controller is configured to determine at least an energy demand of the well cementing system. The controller is also configured to control the electric drive system and the torque generating system to output at least one of the first energy supply via the electric drive system and the second energy supply via the torque generating system, based on the energy demand of the well cementing system.

In another aspect of the present disclosure, a well cementing system is provided. The well cementing system includes a pump. The well cementing system also includes a hybrid drive system operatively coupled with the pump. The hybrid drive system includes an electric drive system that generates a first energy supply. The electric drive system includes one or more electric motors. The hybrid drive system also includes a torque generating system that generates a second energy supply. The torque generating system includes one or more torque generating devices. The electric drive system and the torque generating system are disposed in a parallel arrangement. The hybrid drive system further includes a controller communicably coupled with each of the electric drive system and the torque generating system. The controller is configured to determine at least an energy demand of the well cementing system. The controller is also configured to control the electric drive system and the torque generating system to output at least one of the first energy supply via the electric drive system and the second energy supply via the torque generating system, based on the energy demand of the well cementing system. The pump is adapted to receive at least one of the first energy supply and the second energy supply.

In yet another aspect of the present disclosure, a method of controlling a well cementing operation is provided. The method includes providing an electric drive system of a hybrid drive system that generates a first energy supply. The electric drive system includes one or more electric motors. The method also includes providing a torque generating system of the hybrid drive system that generates a second energy supply. The torque generating system includes one or more torque generating devices. The electric drive system and the torque generating system are disposed in a parallel arrangement. The method further includes determining, by a controller, at least an energy demand of the well cementing operation. The controller is communicably coupled with the electric drive system and the torque generating system. The method includes controlling, by the controller, the electric drive system and the torque generating system to output at least one of the first energy supply via the electric drive system and the second energy supply via the torque generating system, based on the energy demand of the well cementing operation. The method also includes receiving, by a pump operatively coupled with the electric drive system and the torque generating system, at least one of the first energy supply and the second energy supply to perform the well cementing operation.

Other features and aspects of this disclosure will be apparent from the following description and the accompanying drawings.

### BRIEF DESCRIPTION OF THE DRAWINGS

FIG. 1 is a schematic flow diagram of a well cementing system, according to an example of the present disclosure;

FIG. 2 is a schematic flow diagram of a well cementing system, according to another example of the present disclosure; and

FIG. 3 is a flowchart for a method of controlling a well cementing operation, according to an example of the present disclosure.

### DETAILED DESCRIPTION

Wherever possible, the same reference numbers will be used throughout the drawings to refer to the same or like parts.

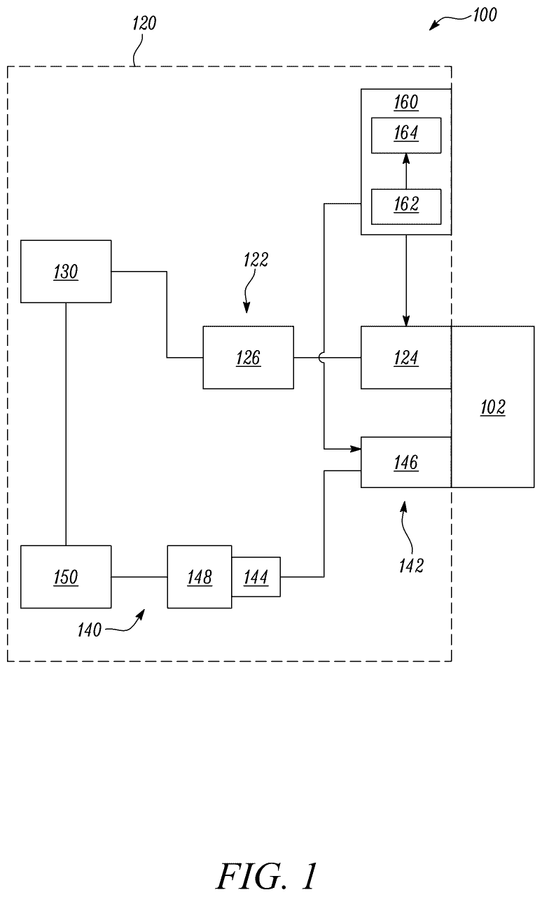

Referring to FIG. 1, a schematic flow diagram of a well cementing system 100 is illustrated. Typically, after drilling and completion of an oil well or a gas well, a cement composition or a cement slurry is introduced into a well bore (not shown) by means of a cementing pipe (not shown). The cement slurry is pumped into an annular space between a casing and walls of the well bore. The casing is a large diameter pipe that is lowered in the well bore and centered in place after a drilling operation.

Further, the cement slurry sets in the annular space, and forms a substantially impermeable barrier, or cement sheath, which isolates the well bore from subterranean zones. Various well cementing operations may be performed to provide a zonal isolation, a casing support, a corrosion protection, an environmental protection, and a well bore control.

The well cementing system 100 includes a pump 102. During a pumping mode performed by the well cementing system 100, the pump 102 may pump the cement slurry into the annular space between the casing and the walls of the well bore. The pump 102 may be a high-pressure and a heavy-duty pump, designed to handle abrasive slurries. In some examples, the pump 102 may be a positive displacement pump which displaces a fixed volume of the cement slurry with each stroke and capable of generating a high pressure needed to overcome friction and hydrostatic pressure in the well bore. In another example, the pump 102 may be a reciprocating pump for smoother flow.

In some cases, the annular space is filled with drilling mud before the well cementing operation, the pump 102 displaces the drilling mud, makes a space for the cement slurry, and ensures sufficient contact between the cement and a formation.

The well cementing system 100 is also used for a pressure testing operation to confirm that the cement has formed a competent seal. During the pressure testing, pressure is applied to the casing and any pressure drops are monitored, which may indicate a leak or failure in the cement sheath.

The well cementing system 100 also includes a hybrid drive system 120 operatively coupled with the pump 102. The hybrid drive system 120 includes an electric drive system 122 that generates a first energy supply. The electric drive system 122 includes one or more electric motors 124. In the illustrated example of FIG. 1, the one or more electric motors 124 is a single electric motor 124. In other examples, the one or more electric motors 124 may include two electric motors, three electric motors, and so on, without limiting the scope of the present disclosure.

The pump 102 of the well cementing system 100 is operatively coupled with the one or more electric motors 124 of the electric drive system 122 and receives the first energy supply to perform the well cementing operation.

The hybrid drive system 120 also includes a direct current (DC) power supply system 130 that provides a DC power supply to the electric drive system 122 and/or a torque generating system 140. In some examples, the hybrid drive system 120 may include an alternating current (AC) power supply system to provide an AC power supply.

In some examples, the DC power supply system 130 may include a battery system (not shown) to provide the DC power supply. In another example, the DC power supply system 130 may include an energy storage system, a fuel cell system, a solar cell system, a generator system, a thermoelectric generator system, and the like, without limiting the scope of the present disclosure.

The electric drive system 122 further includes a first inverter 126 disposed between the DC power supply system 130 and the one or more electric motors 124. The first inverter 126 is an electronic device that transforms the DC power supply into an AC power supply. In some cases, the first inverter 126 may be eliminated from the electric drive system 122 if the hybrid drive system 120 includes the AC power supply system.

The first inverter 126 receives the DC power supply from the DC power supply system 130 and supplies the AC power supply to the one or more electric motors 124 for operations of the one or more electric motors 124.

The hybrid drive system 120 further includes the torque generating system 140 that generates a second energy supply. Specifically, the electric drive system 122 and the torque generating system 140 are disposed in a parallel arrangement. In some examples, each of the electric drive system 122 and the torque generating system 140 may be operated at the same time. Alternatively, it is also possible that only one of the electric drive system 122 and the torque generating system 140 operates at a given time instance.

The torque generating system 140 includes one or more torque generating devices 142. In the illustrated example of FIG. 1, the one or more torque generating devices 142 includes a hydraulic pump 144 and a hydraulic motor 146 operatively coupled with the hydraulic pump 144. In some examples, the one or more torque generating devices 142 may include a pneumatic pump and a pneumatic motor, without limiting the scope of the present disclosure.

The pump 102 of the well cementing system 100 is operatively coupled with the torque generating system 140. Specifically, the pump 102 of the well cementing system 100 is operatively coupled with the hydraulic pump 144 of the torque generating system 140 and receives the second energy supply to perform the well cementing operation.

The torque generating system 140 also includes an electric motor 148 to operate the hydraulic pump 144. The torque generating system 140 further includes a second inverter 150 disposed between the DC power supply system 130 and the electric motor 148. The second inverter 150 receives the DC power supply from the DC power supply system 130 and supplies the AC power supply to the electric motor 148 for operation of the electric motor 148. Based on receipt of the AC power supply, the electric motor 148 operates the hydraulic pump 144 to generate the second energy supply. The second inverter 150 is an electronic device that transforms the DC power supply into the AC power supply. In some cases, the second inverter 150 may be eliminated from the torque generating system 140 if the hybrid drive system 120 includes the AC power supply system.

The hybrid drive system 120 further includes a controller 160 communicably coupled with each of the electric drive system 122 and the torque generating system 140. The controller 160 determines at least an energy demand of the well cementing system 100. The energy demands of the well cementing system 100 may be a low torque and a low power to meet a zero-speed capability of the pump 102 or a high torque and a high power during an operation of the pump 102 in a peak shave mode. The peak shave mode is where the pump 102 needs the high torque and the high power to perform a desired operation, for example, the pumping operation of the pressure testing.

The controller 160 controls the electric drive system 122 and the torque generating system 140 to output the first energy supply via the electric drive system 122 and/or the second energy supply via the torque generating system 140, based on the energy demand of the well cementing system 100. The controller 160 determines one or more of a function to be performed by the pump 102 and a speed requirement of the pump 102 to direct the first energy supply via the electric drive system 122 and/or the second energy supply via the torque generating system 140 towards the pump 102.

The controller 160 includes one or more memories 162. The one or more memories 162 store a data related to range of values for a torque and a power suitable for the peak shave mode and a range of values for the torque and the power suitable to meet the zero-speed capability of the pump 102.

The one or more memories 162 may include any means of storing information, including a hard disk, an optical disk, a floppy disk, read only memory (ROM), random access memory (RAM), programmable ROM (PROM), electrically erasable PROM (EEPROM), or other computer-readable memory media.

The controller 160 also includes one or more processors 164 communicably coupled with the one or more memories 162. The one or more processors 164 control the electric drive system 122 and the torque generating system 140 to output the first energy supply via the electric drive system 122 and/or the second energy supply via the torque generating system 140 based on the energy demand of the well cementing system 100.

It should be noted that the one or more processors 164 may embody a single microprocessor or multiple microprocessors for receiving various input signals and generating output signals. Numerous commercially available microprocessors may perform the functions of the one or more processors 164. The one or more processors 164 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The one or more processors 164 may include one or more components that may be operable to execute computer executable instructions or computer code that may be stored and retrieved from the one or more memories 162.

Further, the pump 102 receives the first energy supply and/or the second energy supply. In one example, the controller 160 controls the electric drive system 122 and the torque generating system 140 to direct, towards the pump 102, each of the first energy supply via the electric drive system 122 and the second energy supply via the torque generating system 140 during the operation of the pump 102 in the peak shave mode. Thus, each of the first energy supply via the electric drive system 122 and the second energy supply via the torque generating system 140 may be used during the operation of the pump 102 in the peak shave mode.

In another example, the controller 160 controls the electric drive system 122 and the torque generating system 140 to direct, towards the pump 102, only the first energy supply via the electric drive system 122 to meet the zero-speed capability of the well cementing system 100. During such instances, the pump 102 will not receive the second energy supply from the torque generating system 140, and the torque generating system 140 may be in an OFF state. Thus, it may be contemplated that the torque generating system 140 may be in an ON state during the operation of the pump 102 in the peak shave mode.

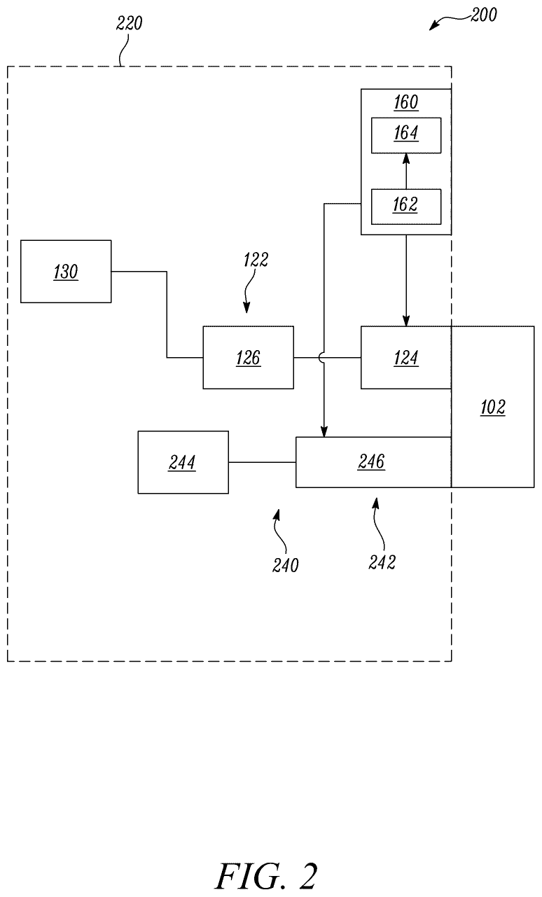

Referring to FIG. 2, a schematic flow diagram of a well cementing system 200 is illustrated, according to another example of the present disclosure. The well cementing system 200 is substantially similar to the well cementing system 100 (see FIG. 1), with common components being referred to by the same numerals. The well cementing system 200 includes a hybrid drive system 220. The hybrid drive system 220 is substantially similar to the hybrid drive system 220 (see FIG. 1), with common components being referred to by the same numerals.

However, the hybrid drive system 220 includes a torque generating system 240 that generates the second energy supply. The torque generating system 240 includes one or more torque generating devices 242. The one or more torque generating devices 242 includes an engine 244 and a transmission 246 operatively coupled with the engine 244. In some examples, the engine 244 may be an internal combustion engine, such as gasoline engine, diesel engine, and the like, without limiting the scope of present disclosure. The transmission 246 may include any device that converts a current engine torque and speed to an appropriate/desired engine torque and speed that the pump needs. In some examples, the transmission 246 may include a torque converter or any other device, without limiting the scope of present disclosure.

It should be noted that the one or more torque generating devices 242 may include any other component or combination of components that can be used to provide additional torque and power required during the operation of the pump 102 in the peak shave mode.

The pump 102 of the well cementing system 200 is operatively coupled with the torque generating system 240. Specifically, the pump 102 of the well cementing system 200 is operatively coupled with the transmission 246 of the torque generating system 240 and receives the second energy supply to perform the well cementing operation. The engine 244 and the transmission 246 together generate the second energy supply which is directed to the pump 102 during the operation of the pump 102 in the peak shave mode.

It should be noted that the controller 160 of the well cementing system 200 operates in a similar manner as explained in relation to the well cementing system 100.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the hybrid drive system 120, 220 of the well cementing system 100, 200 including the electric drive system 122 and the torque generating system 140, 240. The electric drive system 122 and the torque generating system 140, 240 are operatively coupled with the pump 102 and supplies the first energy supply and/or the second energy supply, respectively, to the pump 102.

The hybrid drive system 120, 220 also includes the controller 160 communicably coupled with each of the electric drive system 122 and the torque generating system 140, 240. In an example, the controller 160 controls the electric drive system 122 and the torque generating system 140, 240 to direct, towards the pump 102, each of the first energy supply via the electric drive system 122 and the second energy supply via the torque generating system 140, 240 during the operation of the pump 102 in the peak shave mode.

In another example, the controller 160 controls the electric drive system 122 and the torque generating system 140, 240 to direct, towards the pump 102, only the first energy supply via the electric drive system 122 to meet the zero-speed capability of the well cementing system 100, 200. The torque generating system 140, 240 may be operated in the OFF state and the electric drive system 122 may operate in an ON state to meet the zero-speed capability of the well cementing system 100, 200. Thus, the torque generating system 140, 240 may be operated in the ON state only when required, i.e. when the pump 102 is required to operate in the peak shave mode.

Further, supplying the first energy supply and/or the second energy supply toward the pump 102, according to the need of the pump 102 of the well cementing system 100, 200 may reduce a power usage and lower an overall operating cost of the well cementing system 100, 200. Furthermore, the hybrid drive system 120, 220 may reduce the use and need of an oversized motor in the electric drive system 122, which may otherwise require larger space for mounting, and may increase packaging costs as well as overall installation costs.

In some cases, the torque generating devices 142 includes the hydraulic pump 144 and the hydraulic motor 146 operatively coupled with the hydraulic pump 144. In other cases, the torque generating devices 242 include the engine 244 and the transmission 246 operatively coupled with the engine 244. Further, an availability of two different type of the torque generating devices 142, 242 may broaden a use of the hybrid drive system 120, 220 and may provide a versatile and efficient solution for a wide range of cementing applications.

Overall, the hybrid drive system 120, 220 may be simple in construction, may be cost-effective, and may be easy to incorporate. Further, the hybrid drive system 120, 220 may be retrofitted on existing well cementing systems. Moreover, the hybrid drive system 120, 220 may be used on a variety of well cementing systems.

FIG. 5 is a flowchart for a method 300 of controlling the well cementing operation. With reference to FIGS. 1 to 3, at step 502, the electric drive system 122 of the hybrid drive system 120, 220 that generates the first energy supply is provided. The electric drive system 122 includes the one or more electric motors 124.

At step 304, the torque generating system 140, 240 of the hybrid drive system 120, 220 that generates the second energy supply is provided. The torque generating system 140, 240 includes the one or more torque generating devices 142, 242. The electric drive system 122 and the torque generating system 140, 240 are disposed in a parallel arrangement.

In one example, the one or more torque generating devices 142 includes the hydraulic pump 144 and the hydraulic motor 146 operatively coupled with the hydraulic pump 144.

In another example, the one or more torque generating devices 242 includes the engine 244 and the transmission 246 operatively coupled with the engine 244.

At step 306, the controller 160 determines at least the energy demand of the well cementing operation. The controller 160 is communicably coupled with the electric drive system 122 and the torque generating system 140, 240.

At step 308, the controller 160 controls the electric drive system 122 and the torque generating system 140, 240 to output the first energy supply via the electric drive system 122 and/or the second energy supply via the torque generating system 140, 240, based on the energy demand of the well cementing operation.

At step 310, the pump 102 operatively coupled with the electric drive system 122 and the torque generating system 140, 240, receives the first energy supply and/or the second energy supply to perform the well cementing operation.

The method 300 further includes a step (not shown) at which the controller 160 determines one or more of the function to be performed by the pump 102 and the speed requirement of the pump 102 to direct the first energy supply via the electric drive system 122 and/or the second energy supply via the torque generating system 140, 240 towards the pump 102.

The method 300 further includes a step (not shown) at which the controller 160 controls the electric drive system 122 and the torque generating system 140, 240 to direct, towards the pump 102, each of the first energy supply via the electric drive system 122 and the second energy supply via the torque generating system 140, 240 during the operation of the pump 102 in the peak shave mode. Alternatively, the method 300 further includes a step (not shown) at which the controller 160 controls the electric drive system 122 and the torque generating system 140, 240 to direct, towards the pump 102, only the first energy supply via the electric drive system 122 to meet the zero-speed capability of the well cementing operation.

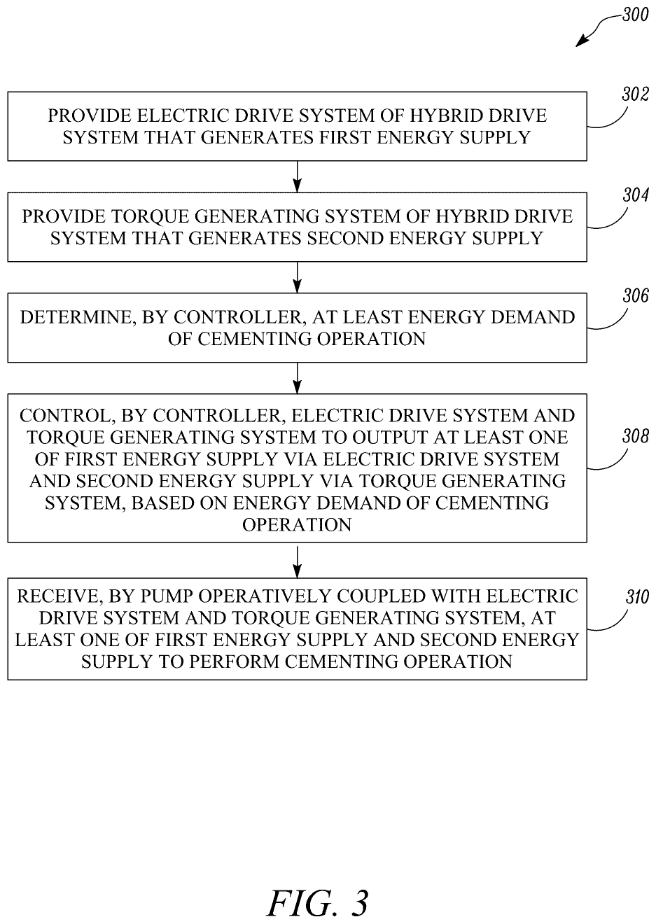

It should be noted that the steps 302, 304, 306, 308, 310 of the method 300 may be performed in a sequence that is different from that explained in relation to FIG. 3. Further, various steps 302, 304, 306, 308, 310 can be performed together

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

1. A hybrid drive system associated with a well cementing system, the hybrid drive system comprising:
an electric drive system that generates a first energy supply, wherein the electric drive system includes one or more electric motors;
a torque generating system that generates a second energy supply, wherein the torque generating system includes one or more torque generating devices, and wherein the electric drive system and the torque generating system are disposed in a parallel arrangement; and
a controller communicably coupled with each of the electric drive system and the torque generating system, wherein the controller is configured to:
determine at least an energy demand of the well cementing system; and
control the electric drive system and the torque generating system to output at least one of the first energy supply via the electric drive system and the second energy supply via the torque generating system, based on the energy demand of the well cementing system.

2. The hybrid drive system of claim 1, wherein the hybrid drive system further includes a direct current (DC) power supply system that provides a DC power supply to at least one of the electric drive system and the torque generating system.

3. The hybrid drive system of claim 2, wherein the electric drive system further includes a first inverter disposed between the DC power supply system and the one or more electric motors, and wherein the first inverter receives the DC power supply from the DC power supply system and supplies an alternating current (AC) power supply to the one or more electric motors for operations of the one or more electric motors.

4. The hybrid drive system of claim 2, wherein the one or more torque generating devices includes a hydraulic pump and a hydraulic motor operatively coupled with the hydraulic pump, and wherein the torque generating system further includes:
an electric motor adapted to operate the hydraulic pump; and
a second inverter disposed between the DC power supply system and the electric motor, wherein the second inverter receives the DC power supply from the DC power supply system and supplies an alternating current (AC) power supply to the electric motor for operations of the electric motor.

5. The hybrid drive system of claim 1, wherein the one or more torque generating devices includes an engine and a transmission operatively coupled with the engine.

6. The hybrid drive system of claim 1, wherein the well cementing system includes a pump adapted to receive at least one of the first energy supply and the second energy supply.

7. The hybrid drive system of claim 6, wherein the controller is configured to determine one or more of a function to be performed by the pump and a speed requirement of the pump to direct at least one of the first energy supply via the electric drive system and the second energy supply via the torque generating system towards the pump.

8. The hybrid drive system of claim 6, wherein the controller is configured to at least one of:
control the electric drive system and the torque generating system to direct, towards the pump, each of the first energy supply via the electric drive system and the second energy supply via the torque generating system during an operation of the pump in a peak shave mode; and
control the electric drive system and the torque generating system to direct, towards the pump, only the first energy supply via the electric drive system to meet a zero-speed capability of the well cementing system.

9. A well cementing system comprising:
a pump; and
a hybrid drive system operatively coupled with the pump, the hybrid drive system including:
an electric drive system that generates a first energy supply, wherein the electric drive system includes one or more electric motors;
a torque generating system that generates a second energy supply, wherein the torque generating system includes one or more torque generating devices, and wherein the electric drive system and the torque generating system are disposed in a parallel arrangement; and
a controller communicably coupled with each of the electric drive system and the torque generating system, wherein the controller is configured to:
determine at least an energy demand of the well cementing system; and
control the electric drive system and the torque generating system to output at least one of the first energy supply via the electric drive system and the second energy supply via the torque generating system, based on the energy demand of the well cementing system, wherein the pump is adapted to receive at least one of the first energy supply and the second energy supply.

10. The well cementing system of claim 9, wherein the hybrid drive system further includes a direct current (DC) power supply system that provides a DC power supply to at least one of the electric drive system and the torque generating system.

11. The well cementing system of claim 10, wherein the electric drive system further includes a first inverter disposed between the DC power supply system and the one or more electric motors, and wherein the first inverter receives the DC power supply from the DC power supply system and supplies an alternating current (AC) power supply to the one or more electric motors for operations of the one or more electric motors.

12. The well cementing system of claim 10, wherein the one or more torque generating devices includes a hydraulic pump and a hydraulic motor operatively coupled with the hydraulic pump, and wherein the torque generating system further includes:
an electric motor adapted to operate the hydraulic pump; and
a second inverter disposed between the DC power supply system and the electric motor, wherein the second inverter receives the DC power supply from the DC power supply system and supplies an alternating current (AC) power supply to the electric motor for operations of the electric motor.

13. The well cementing system of claim 9, wherein the one or more torque generating devices includes an engine and a transmission operatively coupled with the engine.

14. The well cementing system of claim 9, wherein the controller is configured to determine one or more of a function to be performed by the pump and a speed requirement of the pump to direct at least one of the first energy supply via the electric drive system and the second energy supply via the torque generating system towards the pump.

15. The well cementing system of claim 9, wherein the controller is configured to at least one of:
control the electric drive system and the torque generating system to direct, towards the pump, each of the first energy supply via the electric drive system and the second energy supply via the torque generating system during an operation of the pump in a peak shave mode; and
control the electric drive system and the torque generating system to direct, towards the pump, only the first energy supply via the electric drive system to meet a zero-speed capability of the well cementing system.

16. A method of controlling a well cementing operation, the method comprising:
providing an electric drive system of a hybrid drive system that generates a first energy supply, wherein the electric drive system includes one or more electric motors;
providing a torque generating system of the hybrid drive system that generates a second energy supply, wherein the torque generating system includes one or more torque generating devices, and wherein the electric drive system and the torque generating system are disposed in a parallel arrangement; and
determining, by a controller, at least an energy demand of the well cementing operation, wherein the controller is communicably coupled with the electric drive system and the torque generating system;
controlling, by the controller, the electric drive system and the torque generating system to output at least one of the first energy supply via the electric drive system and the second energy supply via the torque generating system, based on the energy demand of the well cementing operation; and
receiving, by a pump operatively coupled with the electric drive system and the torque generating system, at least one of the first energy supply and the second energy supply to perform the well cementing operation.

17. The method of claim 16, wherein the one or more torque generating devices includes a hydraulic pump and a hydraulic motor operatively coupled with the hydraulic pump.

18. The method of claim 16, wherein the one or more torque generating devices includes an engine and a transmission operatively coupled with the engine.

19. The method of claim 16 further comprising determining, by the controller, one or more of a function to be performed by the pump and a speed requirement of the pump to direct at least one of the first energy supply via the electric drive system and the second energy supply via the torque generating system towards the pump.

20. The method of claim 16 further comprising:
controlling, by the controller, the electric drive system and the torque generating system to direct, towards the pump, each of the first energy supply via the electric drive system and the second energy supply via the torque generating system during an operation of the pump in a peak shave mode; or
controlling, by the controller, the electric drive system and the torque generating system to direct, towards the pump, only the first energy supply via the electric drive system to meet a zero-speed capability of the well cementing operation.
